(19) United States
(12) Patent Application Publication
(10) Pub. No.: US 2018/0130564 A1
(43) Pub. Date: May 10, 2018

(54) ELECTROMAGNETIC FIELD RESISTANT SUPPORT GARMENT

(71) Applicant: Brenna Ann Hardman, Solana Beach, CA (US)

(72) Inventor: Brenna Ann Hardman, Solana Beach, CA (US)

(21) Appl. No.: 15/803,306

(22) Filed: Nov. 3, 2017

Related U.S. Application Data
(60) Provisional application No. 62/417,999, filed on Nov. 4, 2016.

(51) Int. Cl. G21F 3/02; A41D 7/00; A41B 9/06; A41B 9/12; A41C 1/16; A41D 1/22; A41C 3/12; A41C 5/00

(52) U.S. Cl. CPC G21F 3/02; A41D 7/00; A41B 9/06; A41C 5/00; A41C 1/16; A41D 1/22; A41C 3/128; A41B 9/12

(57) ABSTRACT

A system and method are disclosed for a support system that can work with a variety of different garments. A support garment that has a non-conductive support wire is described. The non-conductive support wire is capable of shielding the body of the wearer from potentially harmful electromagnetic fields. A method of manufacturing a support garment is also described, which includes adding the non-conductive support wire to the support garment.

### BACKGROUND OF THE INVENTION

### Field of the Invention

The invention is in the field of a device and material manufacturing. More specifically, the invention is in the field of electromagnetic field (EMF) reduction support garments and their manufacture.

### Background

The use of underwire elements for shaping and supporting the lower periphery of brassiere (or bra) cups has long been known in the art. The term “underwire” has been in common use to refer to such elements. An underwire can take any of a number of forms such as, for example, a pair of metal U-shaped wire frames corresponding with a pair of respective bra cups. Alternatively, an underwire can be a single integral wire frame that traverses both bra cups. These various underwires are typically formed from metal. The conventional purpose of these underwire frames is to provide support for the bust while being flexible enough to conform easily to the wearer's body for appearance.

### SUMMARY OF THE INVENTION

The drawbacks associated with conventional metal underwire frames are that they attract electromagnetic fields.

Electric, magnetic and electromagnetic fields, rays, radiation, force, waves, particles, and wave particles, hereinafter referred to generically as “electromagnetic fields” or “electromagnetism,” surround us in everyday life. The strength of these electromagnetic fields can be described and measured as their intensity, amplitude, energy, energy density, power, strength, force, flux, presence and/or number of electromagnetic fields. The effect of these phenomena increase in intensity as our exposure increases to, among other sources, inside-home power lines, outside overhead and buried power lines, household appliances, televisions, computers, electric heating elements, industrial electric motors, subways, cell-phones, medical devices, and even those emanating from violent solar flares. As a result, exposure of the reproductive tracts, systems, tissues, organs, fetuses, of males and pregnant or non-pregnant females to these fields also increases. A number of studies in both animals and in humans indicate that there are adverse effects on the reproductive systems, tracts, organs, tissues, or other living entities in females associated with these electromagnetic radiations.

The concept of an underwire can be traced to an 1893 patent that describes a breast supporting device using a rigid plate under the breasts for stability. The modern underwire bra was designed in the 1930s, and gained widespread popularity by the 1950s. As of 2005, underwire bras were the largest and fastest growing segment of the bra market. Underwire bras are occasionally linked to health conditions including breast pain, mastitis, metal allergies, and cancer. Underwire bras are built with a semi-circular “underwire,” “bra wire,” or “wire” embedded in the wire channel that circles the bottom and sides of each cup. One end, or head element, of the underwire is close to the front and center of the bra, and the other end close to the armhole.

A metallic underwire is a thin strip of metal, usually with a nylon coating at both ends. Metals used include steel, nickel, titanium, and a shape memory alloy. According to underwire manufacturer S & S Industries of New York, which supplies underwire for bra makers such as Bali, Playtex, Vanity Fair, Victoria's Secret, Warner's, and other bra labels, about 70 percent of women who wear bras wear steel underwire bras. The metal tends to snap or break in weather that is too cold, yet nearly all underwire bras contain metal underwires coated with plastic.

In a 1975 article, Chinese Lessons For Modern Chiropractors, Dr. George Goodheart explained what he calls the “Antenna Effect.” Essentially, he discovered that by taping a small metal ball over an acupuncture point, you could achieve longer-term stimulation to the point in question. This discovery led to what are now known as AcuAids, which are small magnetic patches that are used by thousands of doctors across the world.

However, any metal constantly applied to an energy channel or point on the body can have a stimulating effect. As described by John D. Andre, D.C., N.D., below the breasts are two important neuro-lymphatic reflex points. The one below the right breast corresponds to the liver and gallbladder. The one below the left breast corresponds to the stomach. In addition, a metal wire can act as an antenna attracting electromagnetic fields that can increase the risk of breast cancer in subjects.

In one study, the overall difference of breast cancer between women who wore their bras 24-hours a day and those who did not wear bras at all was a 125-fold difference. Based on the results of this study, the link between bras and breast cancer is about three times greater than the link between cigarette smoking and cancer.

A system and method are disclosed in accordance with the various aspects of the disclosure that provides a support garment that is resistant to or reduces EMF exposure (including RF radiation) and is comfortable to wear, resilient, has structural rigidity and provides adequate support for the wearer. A support garment structure/system, such as a bra or brassiere is designed to reduce and eliminate breast exposure to EMFs, as well as metal and/or plastics poisoning, due to the underwires conventionally worn in bras. This support system may be made of a non-conductive material, including carbon fiber, bamboo and plastic materials, and other composite materials for use in underwires in bras. In a wireless age with invisible magnetic fields, a non-conductive wire in the support garment can protect the wearer from exposure to electromagnetic fields. The scope of the invention includes any other structure that provides support to the breasts.

Another aspect of the disclosure is to provide an EMF resistant support wire that provides improved safety, comfort and support. Some embodiments provide a support garment comprising a non-conductive support wire. In some embodiments, the non-conductive support wire shields electromagnetic fields from about 3 kHz to about 300 GHz.

Some embodiments provide a support garment comprising a non-conductive support wire, an outer layer, an inner layer, and wherein the outer layer and the inner layer encase the non-conductive support wire.

Some embodiments provide a method of manufacturing a support garment comprising adding a non-conductive support wire to the garment. Optionally, a conductive wire that was originally in the supporting garment may be removed.

Another aspect of the invention is to provide a cushioned composite and/or carbon fiber underwire that avoids having a thick appearance and/or a stiff, rigid feel.

Another aspect of the invention is to provide a carbon fiber and/or composite underwire that is adjustable and therefore can be used in a number of different sized brassieres.

Another aspect of the invention is to provide a cushioned underwire structure that can be conveniently assembled in the brassiere.

Another aspect of the invention is to replace current metal underwires with EMF resistant underwires.

### BRIEF DESCRIPTION OF THE DRAWINGS

The figures are for illustration purposes only.

FIG. 1 illustrates a support garment comprising a non-conductive support wire;

FIG. 2 illustrates a non-conductive support wire;

FIG. 3 illustrates a cushioned, non-conductive support wire comprised of a section of an outer layer and an inner layer wherein the layers encase the non-conductive support wire.

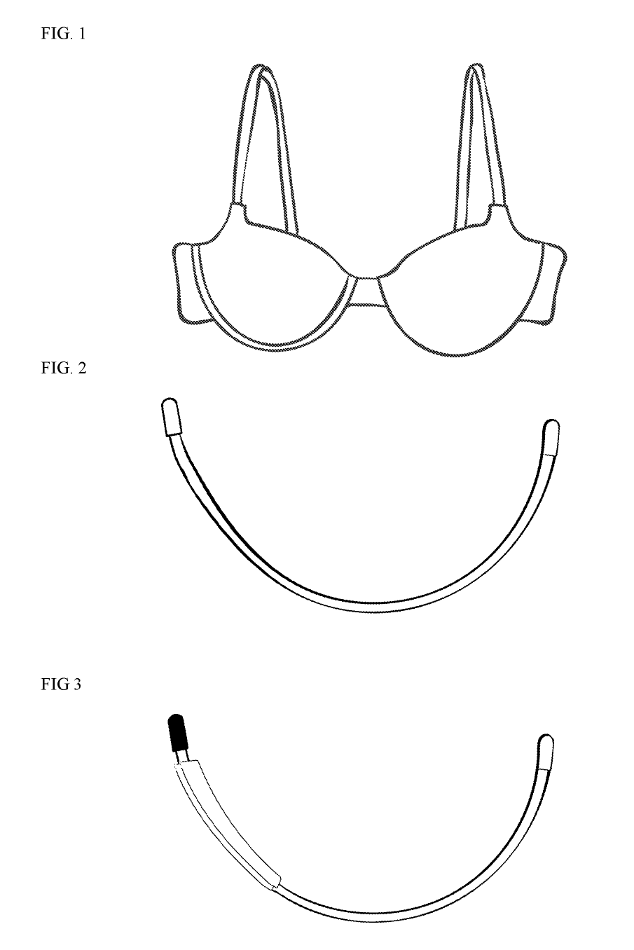

### DETAILED DESCRIPTION OF THE PREFERRED EMBODIMENT

All publications and patents cited in this specification are herein incorporated by reference as if each individual publication or patent were specifically and individually indicated to be incorporated by reference.

The disclosure relates to the use of non-conducting materials for support wires and methods of manufacturing the same. One such embodiment is a carbon fiber support wire, but any material may be incorporated as a support wire that reduces or resists EMF. As used herein, the term “supporting garments” is intended to include brassieres, corsets, swimsuits, peignoirs, camisoles, sports bras, bralettes, bathing suits and other foundation garments that have breast-supporting cups and/or built in support structures. Support garments also include any garment that includes a portion with the support structure, for example, a dress or gown. In some embodiments, the non-conducting support wires are designed to be attached to the regions of a support garment that is positioned under the breasts to provide shape and support for the breast cups. Such support wire may be called underwire in bras. Corsets, dresses, and gowns may include support wires as the boning/ribs/stays.

With today's increasing concern about breast cancer and with the public's uncertainty of where the causes of this life-threatening disease lie, women need to protect themselves as much as possible. The cause of the recent increase in breast cancer has not been understood, but the general rate of increased cancer incidence is so large that the United States Department of Health and Human Services has speculated that “U.S. citizens face a growing cancer risk from some as yet unidentified environmental factors.” As there are increasingly more women in the workplace exposed to the possible hazards of electromagnetic fields over long periods of time, this source of radiation cannot be overlooked.

The sources of surrounding electromagnetic fields include, but are not limited to, wireless communications and are generated from wireless LAN protocols (such as Bluetooth), metropolitan area networks (such as WiMax), global navigation satellite systems (GNSS), American global positioning system (GPS), mobile Broadband wireless (such as 3G/4G) and mobile phone networks (such as T-mobile, Verizon, AT&T). Other sources of surrounding electromagnetic fields include household appliances and electronic devices, such as microwave ovens, wireless televisions, and computers. In some embodiments, the electromagnetic field also includes radio frequency (RF) radiations. Many of these electromagnetic fields operate in about the 3 kHz to 300 GHz frequency range. In some embodiments, the support wire is made from a ultra-high-molecular-weight polyethylene (UHMWPR). Examples of UHMWPR include, but are not limited to, carbon fibers, glass fibers, Kevlar® fibers, UHMWPR fibers, high-modulus polyethylene (HMPE) fibers, high-performance polyethylene (HPPE) fibers, boron fibers, cellulose fibers, and any combination of the above fibers. Examples of cellulose fibers include, but are not limited to, jute, hemp, abaca, sisal, flax, palm rattan, and wood. In accordance with another embodiment, these fibers are imbedded in a polymer matrix to form a composite material. Examples of polymers used to form a polymer matrix include, but are not limited to, polyester, vinyl ester, epoxy, phenolic, polyimide, polyamide, polypropylene, and polyether ether ketone (PEEK). In some embodiments, the support wire is non-metallic.

In some embodiments, the underwire comprises a carbon fiber material. There are low modulus, standard modulus, intermediate modulus, and high modulus types of carbon. Also Polyacrylonitrile (PAN) Type carbon fiber, a type of carbon fiber produced by carbonization of a polyacrylonitrile precursor, and Pitch Type carbon fiber, another type of carbon fiber produced by carbonization of a oil/coal pitch precursor, are within the scope of the various aspects of the disclosure.

In some embodiments, the support wire may further include a plurality of blended layers, each layer having unique and separate attributes. In some embodiments, at least one layer may be fabricated to at least partially prevent against interaction with EMFs. Various types of materials may be utilized in the blended layer, including, but not limited to, bamboo fiber, polyester/cotton blended fibers, and a microwave absorbing carbon fabric. These materials are generally effective because they are non-conductive. In other embodiments, numerous other combinations of materials that are effective for blocking and shielding electromagnetic fields may also be used in the blended layers. While one embodiment discussed focus on some aspects of the disclosure, such as carbon fiber, it may be substituted by other materials.

In some embodiments, the outer and inner layer of the support wire may be configured to allow for physical activity, absorbing perspiration, and repel moisture, while still providing comfort and EMF protection. Suitable outer and inner layer materials may include, without limitation, polyester, nylon, lycra, and spandex to mention a few. These materials can be used to absorb or repel water, while at the same time providing support and being breathable. Suitable outer and inner layer materials for other contexts may also include, without limitation, cotton, satin, silk, or any other clothing fabric. In some embodiments, at least one inner layer and other layer may join through sewing.

In some embodiments, EMF resistant support wire can provide improved safety, comfort and support. In some embodiments, the support wire may be a cushioned support wire that avoids having a thick appearance and/or a stiff, rigid feel. Another aspect of the disclosure is to provide a non-conductive support wire that is designed to be adjustable and therefore can be used in any number of different sized garments. An adjustable support wire may become longer or shorter based on the size and shape of a subject. Another aspect of the disclosure is to provide a cushioned support wire structure that can be conveniently assembled in the garments.

Another aspect of the invention is to replace current metal wires with EMF resistant support wire. In a further embodiment, the system for manufacturing the support wire includes using a 3D printer. The 3D printer will enable making customizable wire shapes that fit best to the particular and individual curves of a body. Thus it is possible to replace the original metal wire in a garment with the non-conductive support wire as disclosed. In accordance with another embodiment, the metal wire can be removed from an existing support garment, the shape or structure of the wire can be copied, and a 3D printer can produce a non-conductive (e.g., carbon fiber) support wire replica of the original metal wire. The carbon fiber wire is then placed into the bra. In another embodiment, the new 3D printed non-conductive underwire is sewn into the bra. In accordance with the aspects of the invention, a system and method are disclosed for removing the old underwire or metal wire and replacing it with a new non-conductive support system, such as the carbon fiber wire and other materials described herein.

In a further embodiment, a manufacturing facility produces or makes the non-conductive support system, such as the carbon fiber wires (or other materials), of a particular cut, in mass quantities. For example, in accordance with various aspects of the invention, bamboo wire is produced at a manufacturing facility that specializes in bamboo.

In a further embodiment, carbon fiber-reinforced polymer, carbon fiber-reinforced plastic or carbon fiber-reinforced thermoplastic (CFRP, CRP, CFRTP or often simply carbon fiber, or even carbon), and light fiber-reinforced polymer that includes carbon fibers can be used to produce the non-conductive support system, as these materials are extremely strong.

In a further embodiment, the non-conductive support system or support wire is produced by graphite-epoxy methods. One method of producing graphite-epoxy parts is by layering sheets of carbon fiber cloth into a mold in the shape of the final product. The alignment and weave of the cloth fibers is chosen to optimize the strength and stiffness properties of the resulting material. The mold is then filled with epoxy and is heated or air-cured. The resulting part is very corrosion-resistant, stiff and strong for its weight.

In a further embodiment, the non-conductive support system or support wire is produced by a compression mold. A compression mold consists of a two-piece (male and female) mold, in some instances made out of aluminum or steel, that are pressed together with a fabric and resin between the two molds. The benefit of which is the speediness of the entire process.

In a further embodiment, bamboo is uses as the non-conducting support system. Bamboo is a wood-like material that is superior in strength and resilience compared to other natural, fibrous building materials. Bamboo grows in two main forms: the woody bamboos (Arundinarieae and Bambuseae) and the understory herbaceous bamboos (Olyreae). Analysis suggests that there are 3-5 major lineages of bamboo. Four major lineages are currently recognized: temperate woody, paleotropical woody, neotropical woody and herbaceous. Bamboo is one of the fastest-growing plants, with reported growth rates of 250 cm (98 inches) in 24 hours. Bamboo, like true wood, is a natural composite material with a high strength-to-weight ratio useful for structures. Bamboo can be cut and laminated into sheets and planks. This process involves cutting stalks into thin strips, planing them flat, and boiling and drying the strips; they are then glued, pressed and finished.

Unless defined otherwise, all technical and scientific terms used herein have the same meaning as commonly understood by one of ordinary skill in the art to which this invention belongs. The verb “couple,” its gerundial forms, and other variants, should be understood to refer to either direct connections or operative manners of interaction between elements of the invention through one or more intermediating elements, whether or not any such intermediating element is recited.

Any methods and materials similar or equivalent to those described herein are not considered abstract ideas and are considered to be significant improvements in the art when used in the practice of the invention. Representative illustrative methods and materials are also described. Additionally, it is intended that equivalents include both currently known equivalents and equivalents developed in the future, i.e., any elements developed that perform the same function, regardless of structure. The scope of the invention, therefore, is not intended to be limited to the exemplary aspects and embodiments shown and described herein.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Therefore, the scope of the invention, therefore, is not intended to be limited to the various aspects and embodiments discussed and described herein.

What is claimed is:

1. A support garment comprising a non-conductive support wire.

2. The support garment of claim 1, wherein the support garment is a brassiere, corset, swimsuit, camisole, or peignoir.

3. The support garment of claim 1, wherein the non-conductive support wire is an underwire.

4. The support garment of claim 1, wherein the non-conductive support wire shields electromagnetic fields from about 3 kHz to about 300 GHz.

5. The support garment of claim 1, wherein the non-conductive support wire is made of at least one material selected from the group consisting of carbon fiber, carbon fiber wire, nickel coated polyester mesh, copper coated polyester mesh, silver coated mesh, bamboo fiber, bamboo wire, polyester blended fibers, cotton blended fibers, microwave absorbing carbon fabric, plastic, and a form of ultra-high-molecular-weight polyethylene.

6. The support garment of claim 1, wherein the non-conductive support wire comprises a form of ultra-high-molecular-weight polyethylene imbedded in a polymer matrix to form a composite material.

7. The support garment of claim 6, wherein the polymer of the polymer matrix is selected from the group consisting of polyester, vinyl ester, epoxy, phenolic, polyimide, polyamide, polypropylene, polyether ether ketone, and a combination thereof.

8. The support garment of claim 1, wherein the non-conductive support wire is cushioned.

9. The support garment of claim 1, wherein the non-conductive support wire is adjustable.

10. The support garment of claim 1, wherein the non-conductive support wire is reinforced.

11. The support garment of claim 1, wherein the non-conductive support wire is produced by graphite-epoxy production methods or compression mold methods.

12. The support garment of claim 1, further comprising:
an outer layer; and
an inner layer,
wherein the outer layer and the inner layer encase the non-conductive support wire.

13. The support garment of claim 12, wherein the inner and outer layers are made of a material selected from the group consisting of nylon, silk, cotton, brocade, denim, satin, velvet, velveteen, polyester, sateen, polished cotton, rayon, spandex, jersey, knits, plastic, beta cloth, oilcloth, lycra, spandex, and a combination thereof.

14. A method of manufacturing a support garment comprising adding a non-conductive support wire to the support garment.

15. The method of manufacturing of claim 14, further comprising encasing the non-conductive support wire between an inner layer and an outer layer.

16. The method of manufacturing of claim 14, further comprising removing a conductive wire from the support garment.

17. The method of manufacturing of claim 16, further comprising copying the conductive wire shape and producing the non-conductive support wire in the same shape.
